(19) United States
(12) Patent Application Publication
(10) Pub. No.: US 2010/0086441 A1
(43) Pub. Date: Apr. 8, 2010

(54) BEAM RADIATING DEVICE, BIO-CHEMICAL ANALYZER INCLUDING THE BEAM RADIATING DEVICE, AND BIO-CHEMICAL ANALYZING SYSTEM INCLUDING THE BIO-CHEMICAL ANALYZER

(75) Inventors: Jeonggun LEE, Seoul (KR); Induk HWANG, Suwon-si (KR); Jongmyeon PARK, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/481,972

(22) Filed: Jun. 10, 2009

(30) Foreign Application Priority Data
Oct. 8, 2008 (KR) 10-2008-0098783

(51) Int. Cl. G01N 21/01; G21K 5/04

(52) U.S. Cl. 422/68.1; 250/492.1

(57) ABSTRACT

Provided are a beam radiating device that is used to operate elements, such as valves, included in a microfluidic device, a bio-chemical analyzer which includes the beam radiating device and is configured to perform various tests by using a bio-sample, and a bio-chemical analyzing system including the bio-chemical analyzer and the microfluidic device. The beam radiating device includes: an energy source which is spaced apart from a target and emits an electromagnetic wave beam; a first pivot unit which pivots the energy source by a first angle on a first pivot axis that does not pass the target; and a second pivot unit which pivots the energy source by a second angle on a second pivot axis that perpendicularly crosses the first pivot axis and does not pass the target.

### CROSS-REFERENCE TO RELATED APPLICATIONS

This application claims priority from Korean Patent Application No. 10-2008-0098783, filed Oct. 8, 2008, in the Korean Intellectual Property Office, the disclosure of which is incorporated herein in its entirety by reference.

### BACKGROUND

1. Field

One or more exemplary embodiments relate to a beam radiating device, which is used to operate a device such as a valve included in a micro fluidic device, a bio-chemical analyzer, which is configured to perform various tests by using a bio-sample and includes the beam radiating device, and a bio-chemical analyzing system including the bio-chemical analyzer and the microfluidic device.

2. Description of the Related Art

Recently, a bio-chemical testing technology for diagnosing a certain disease or determining existence of a certain component using a fluid sample, such as a small amount of blood or urine, has been developed. A microfluidic device used in bio-chemical tests includes a chamber for containing the small fluid sample, a channel through which a fluid flows, and a valve for controlling the flow of the fluid. A bio-chip is a device which is used to perform a test including a bio-chemical reaction on a small chip, and specifically, a lab-on-a-chip is a device which processes and manipulates a fluid by performing various operations on one chip.

Operating pressure is required to transfer the fluid in the micro fluidic device, and capillary pressure or pressure generated by a separate pump is used as the operating pressure. Recently, a disc type micro fluidic device, which manipulates a fluid by using a centrifugal force generated by rotating the disc type micro fluidic device including a chamber and a channel, has been developed. Such a disc type microfluidic device may also be called a lab compact disc (CD) or a lab-on-a-CD.

A bio-chemical analyzer sets an external condition suitable for generating a reaction of a measurable bio-sample inside the microfluidic device, and detects a result of the reaction. To open/close a valve that controls the flow of a fluid or to perform a reaction, such as a lysis reaction, an electromagnetic wave, such as a laser, may be irradiated on a target location of the microfluidic device. When the microfluidic device includes a plurality of valves, arrangement of the valves in relation to a beam radiating device takes a long time, and thus it is difficult to reduce a bio-chemical analyzing time.

### SUMMARY

One or more exemplary embodiments may include a beam radiating device which emits an electromagnetic wave beam, a bio-chemical analyzer including the beam radiating device, and a bio-chemical analyzing system including the bio-chemical analyzer.

Additional aspects are set forth in part in the description which follows and, in part, are apparent from the description, or may be learned by practice of the invention.

According to one or more embodiments, there is provided a beam radiating device which aims and irradiates an electromagnetic wave beam on a target, the beam radiating device including: an energy source which is spaced apart from the target and emits the electromagnetic wave beam; a first pivot unit which pivots the energy source by a predetermined first angle based on a first pivot axis that does not pass the target; and a second pivot unit which pivots the energy source by a predetermined second angle based on a second pivot axis that perpendicularly crosses the first pivot axis and does not pass the target.

According to one or more embodiments, there is provided a bio-chemical analyzer including: a mount which supports a microfluidic device including at least one beam incident zone on which an electromagnetic wave beam is incident; and a beam radiating device which aims and irradiates an electromagnetic wave beam on the beam incident zone of the microfluidic device supported by the mount, wherein the beam radiating device may include: an energy source which is spaced apart from the mount and emits the electromagnetic wave beam; a first pivot unit which pivots the energy source by a predetermined first angle based on a first pivot axis that does not pass the mount; and a second pivot unit which pivots the energy source by a predetermined second angle based on a second pivot axis that perpendicularly crosses the first pivot axis and does not pass the mount.

According to one or more embodiments, there is provided a bio-chemical analyzing system including: a microfluidic device which contains a sample to be analyzed and includes at least one beam incident zone on which an electromagnetic wave beam is incident; and a bio-chemical analyzer which irradiates an electromagnetic wave beam on the beam incident zone to analyze the sample.

The first pivot axis or the second pivot axis may pass above and parallel to a microfluidic device support surface of the mount.

The first pivot unit may include a first actuator which is connected to the energy source and provides power to pivot the energy source based on the first pivot axis.

The second pivot unit may include: a pivot plate which fixes and supports the first actuator; and a second actuator which provides power to pivot the pivot plate based on the second pivot axis.

The energy source may be a light source emitting a light beam.

The bio-chemical analyzer may further include a heat radiating element attached to the light source to prevent the light source from being overheated.

The bio-chemical analyzer may further include an f-θ lens for uniformly maintaining a diameter of a light beam incident on a surface of the microfluidic device, regardless of a distance between the light source and the beam incident zone.

The bio-chemical analyzer may further include a collimating lens fixed on the light source to uniformly maintain a diameter of a light beam emitted from the light source.

The mount may be a turntable that supports and rotates the microfluidic device.

The bio-chemical analyzer may further include a home position detection unit which detects a home position formed on the microfluidic device.

The beam incident zone may include a valve which controls flow of a fluid contained in the microfluidic device.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a perspective view illustrating a bio-chemical analyzing system according to an exemplary embodiment;

FIG. 2 is a plan view illustrating an exemplary embodiment of a microfluidic device included in the bio-chemical analyzing system of FIG. 1;

FIG. 3 is a cross-sectional view taken along a line III-III of FIG. 1;

FIG. 4 is a cross-sectional view taken along a line IV-IV of FIG. 1;

FIG. 5 is an enlarged diagram of an area V of FIG. 4; and

FIG. 6 is a cross-sectional view illustrating a bio-chemical analyzing system according to another exemplary embodiment.

### DETAILED DESCRIPTION

Exemplary embodiments will be described below in detail with reference to accompanying drawings.

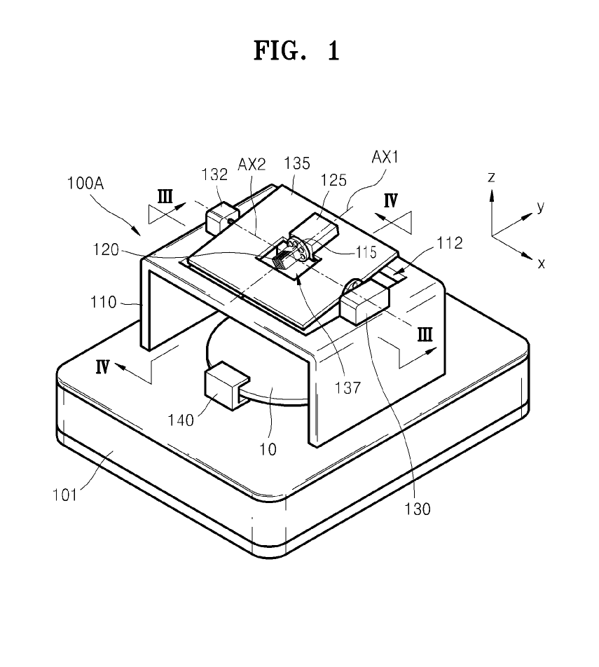

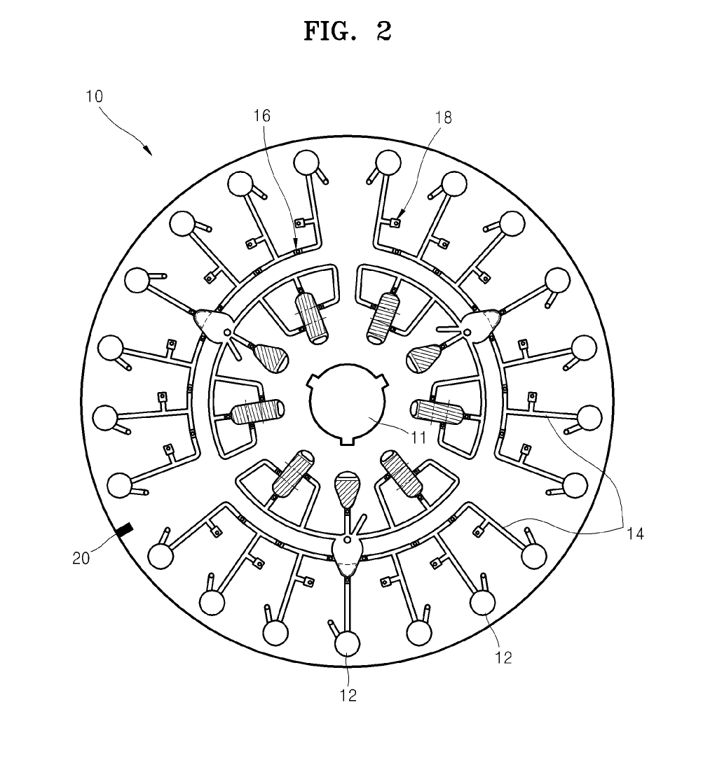

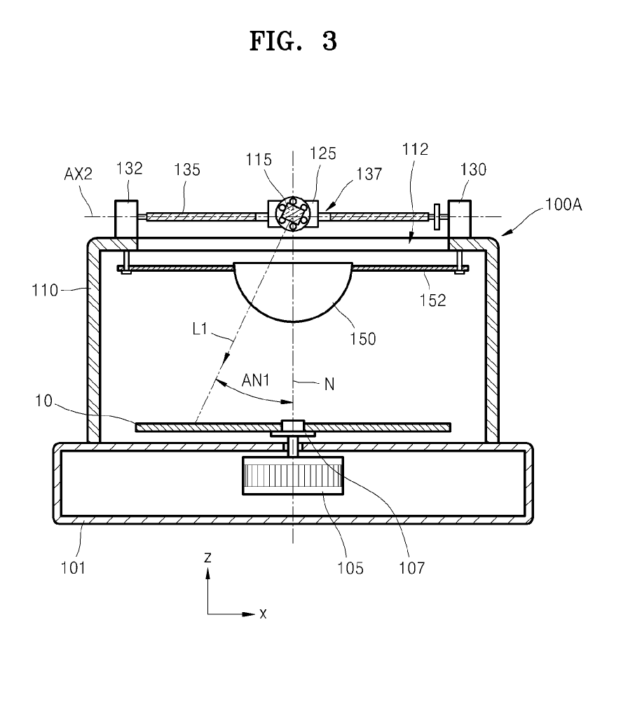

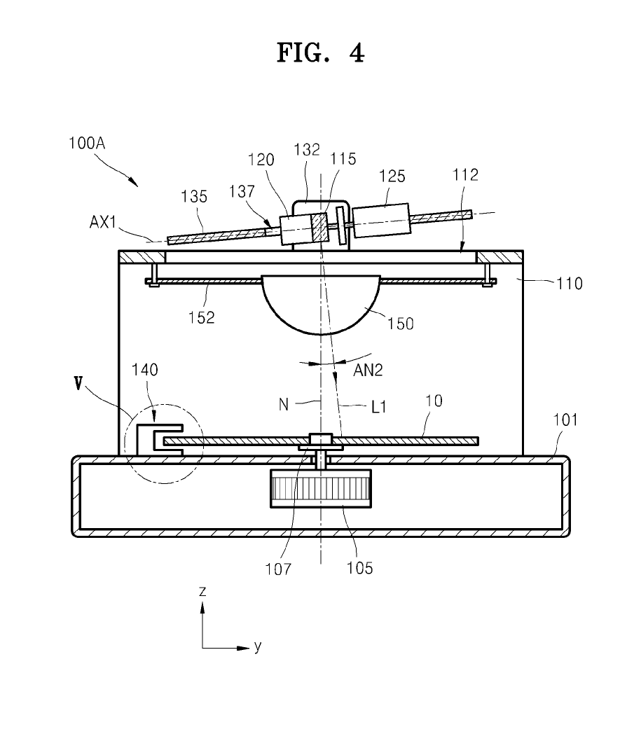

FIG. 1 is a perspective view illustrating a bio-chemical analyzing system according to an exemplary embodiment. FIG. 2 is a plan view illustrating an exemplary embodiment of a microfluidic device 10 included in the bio-chemical analyzing system of FIG. 1, FIG. 3 is a cross-sectional view taken along a line III-III of FIG. 1, and FIG. 4 is a cross-sectional view taken along a line IV-IV of FIG. 1.

Referring to FIG. 1, the bio-chemical analyzing system includes a bio-chemical analyzer 100A and the microfluidic device 10 installed in the bio-chemical analyzer 100A. Referring to FIG. 2, the microfluidic device 10 includes structures in a disc type platform, wherein the structures are arranged in such a way that a certain reaction is performed by using a bio-sample, such as blood. The structures include chambers 12, which contain a bio-sample or a fluid such as a buffer solution that is to be analyzed, channels 14 which provides a flow path for the fluid, and valves 16 and 18 which control the flow of fluid via the channel 14. A turntable mounting hole 11 through which a turntable 107 (refer to FIGS. 3 and 4) is inserted, is provided in the center of the microfluidic device 10, and a home position 20 used as a basis for determining locations of the structures of the microfluidic device 10 is provided on the edge of the microfluidic device 10.

The microfluidic device 10 is easily deformed, optically transparent, and may be formed of a plastic material, such as polymethyl methacrylate (PMMA), polydimethylsiloxane (PDMS), or polycarbonate (PC), having a biologically inactive surface. However, the microfluidic device 10 is not limited these materials, as long as the microfluidic device 10 is formed of a material having chemical and biological stability, optical transparency, and mechanical processability. A platform of the microfluidic device 10 may be formed of plates in several layers. Engraved structures corresponding to the chambers 12 and the channels 14 are formed on facing surfaces of the plates, and by connecting the plates, a space and a path respectively corresponding to the chambers 12 and the channels 14 are provided inside the platform. The plates may be connected to each other by using an adhesive agent, a double-sided adhesive tape, ultrasonic fusion, laser welding or other bonding means.

The valves 16 may be normally closed valves which open flow of a closed-off fluid. The valves 18 may be normally opened valves 18 which close-off flow of a flowing fluid. When the valves 16 and 18 are formed of, for example, a phase transition material such as paraffin or a composition including a phase transition material and a plurality of metal oxide particles dispersed in the phase transition material, the normally closed valves 16 open the flow of the closed fluid when an electromagnetic wave beam is incident thereon, and the normally opened valves 18 close the flow of the opened fluid when the electromagnetic wave beam is incident thereon. Accordingly, the valves 16 and 18 are disposed in a beam incident zone. To perform a certain reaction, such as a lysis reaction, a laser beam may be irradiated on a cell of a sample. In this case, the chambers 12 may be included in a beam incident zone, as the certain reaction is performed in the chambers 12.

Referring to FIG. 1, the bio-chemical analyzer 100A includes a mount which supports the microfluidic device 10 and a beam radiating device which aims and irradiates an electromagnetic wave beam on the valves 16 and 18, which are the beam incident zones of the microfluidic device. Referring to FIGS. 3 and 4, the mount of the bio-chemical analyzer 100A is the turntable 107 that supports and quickly rotates the microfluidic device 10. A motor 105 that provides rotation power to the turntable 107 is installed inside a base 101. The turntable 107 is inserted into the microfluidic device 10 via the turntable mounting hole 11 of FIG. 2, thereby mounting the microfluidic device 10 on the turntable 107.

The beam radiating device includes an energy source which is spaced apart from and located above the turntable 107 and emits an electromagnetic wave beam, a first pivot unit which rotatably pivots the energy source on a first pivot axis AX1 that does not pass the turntable 107, and a second pivot unit which rotatably pivots the energy source on a second pivot axis AX2 that perpendicularly crosses the first pivot axis AX1 and does not pass the turntable 107.

In the current embodiment, the energy source is a light source 115 that emits a light beam downward. The light source 115 may include a laser diode that emits a laser L1 with a strong straightness. The light source 115 may include a heat radiating element 120, such as a heat sink to prevent the light source 115 from being overheated. The light source 115 is located on an extension line of a rotation axis N of the microfluidic device 10.

The first pivot unit includes a first actuator 125 which is connected to the light source 115 and pivots the light source 115 on the first pivot axis AX1. The first actuator 125 may be fixed and supported by a pivot plate 135. The pivot plate 135 includes a pivot plate opening 137 to avoid interference with the laser L1 emitted downward from the light source 115. The first actuator 125 pivots the light source 115 by a predetermined first angle AN1 (refer to FIG. 3) on the first pivot axis AX1, and stops a rotating operation. The first actuator 125 pivots the light source 115 by the first angle AN1 by using servo control.

The second pivot unit includes the pivot plate 135 which fixes and supports the first actuator 125, and a second actuator 130 pivots the pivot plate 135 on the second pivot axis AX2. The second pivot axis AX2 passes above and substantially parallel to a microfluidic device support surface of the turntable 107. Referring to FIG. 3, the microfluidic device support surface of the turntable 107 substantially perpendicularly crosses the rotation axis N of the microfluidic device 10, and thus the second pivot axis AX2 and the rotation axis N substantially perpendicularly cross each other. A pivot supporter 132 supports the pivot plate 135 along with the second actuator 130 so that the pivot plate 135 is pivotable.

The second actuator 130 and the pivot supporter 132 are fixed and supported by a bridge 110 supported by the base 101. The bridge 110 includes a bridge opening 112 so that a pivot angle of the pivot plate 135 is not restricted. The second actuator 130 pivots the light source 115 by a predetermined second angle AN2 (refer to FIG. 4) on the second pivot axis AX2, and then stops a rotating operation. As shown in FIG. 4, the pivot plate 135 and the first actuator 125 are connected to each other, and thus when the pivot plate 135 is pivoted by the second angle AN2 on the second pivot axis AX2, the first pivot axis AX1 inclines by a same angle as the second angle AN2. The second actuator 130 pivots the light source 115 by the second angle AN2 according to the servo control.

The microfluidic device 10 includes a plurality of beam incident zones, such as the valves 16 and 18 of FIG. 2. A distance between the light source 115 and a beam incident zone changes according to a location of the beam incident zone. The bio-chemical analyzer 100A includes an f-θ lens 150 between the light source 115 and the turntable 107 to uniformly maintain a diameter of the light beam incident on the beam incident zone on the surface of the micro fluidic device 10 despite the change of distance between the light source 115 and the beam incident zone. The diameter of the laser L1 incident on the surface of the microfluidic device 10 via the f-θ lens 150 is maintained smaller than about 1.5 mm, regardless of the location of the beam incident zone.

The laser L1 may be irradiated on a certain beam incident zone by installing the microfluidic device 10 on the turntable 107, rotating the pivot plate 135 by the second angle AN2 on the second pivot axis AX2 by driving the second actuator 130 after checking the location of the certain beam incident zone (for example, a valve) on which the laser L1 needs to be irradiated, rotating the light source 115 by the first angle AN1 on the first pivot axis AX1 by driving the first actuator 125, and then emitting the laser L1 by transmitting a signal to the light source 115. Since the beam incident zone and the light source 115 are aligned by rotating the first and second pivot axes AX1 and AX2 without moving the light source 115 in a straight line, the efficiency of a beam irradiating operation and a bio-chemical analysis operation including the beam irradiating operation is substantially increased.

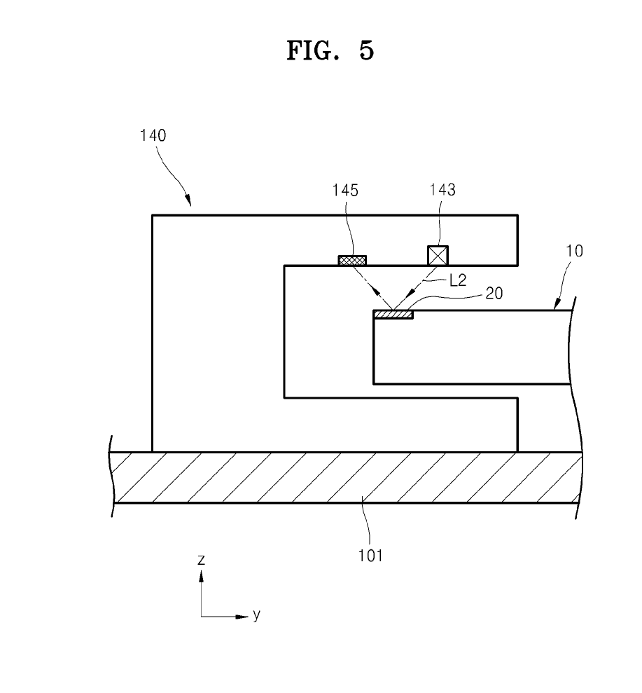

The bio-chemical analyzer 100A includes a home position detection unit 140 for detecting the home position 20 of FIG. 2 formed on the microfluidic device 10. FIG. 5 is an enlarged diagram of the home position detection unit 140 of FIG. 4. Referring to FIG. 5, the home position detection unit 140 includes a light source 143 which emits a light beam L2 toward the edge of the micro fluidic device 10 mounted on the turntable 107, and a light detection unit 145 which detects the light beam L2 reflected on the home position 20. The light source 143 may include a laser diode, and the light detection unit 145 may include a photo diode.

While the microfluidic device 10 makes a full revolution on the turntable 107 of FIG. 4, the light source 143 continuously irradiates the light beam L2 toward the edge of the microfluidic device 10. When the light beam L2 is irradiated on portions other than the home position 20, the light beam L2 is mostly absorbed or diffused, and thus the light detection unit 145 is unable to detect the light beam L2 reflected by the micro fluidic device 10. However, the home position 20 is coated with, for example, a highly reflective material such as a metal, and thus when the light beam L2 is incident on the home position 20, the light beam L2 is reflected and detected by the light detection unit 145. The detected location may be determined to be a standard location for controlling rotation of the microfluidic device 10.

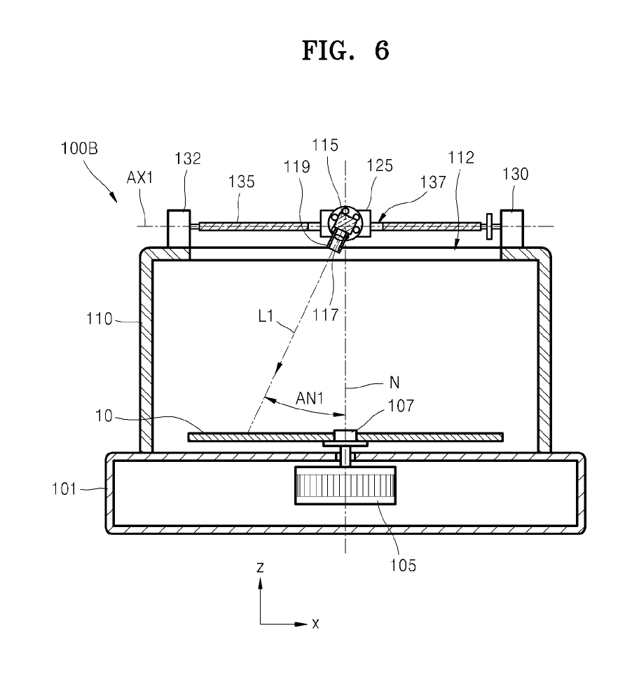

FIG. 6 is a cross-sectional view illustrating a bio-chemical analyzing system according to another exemplary embodiment. Similar to the bio-chemical analyzing system of FIG. 1, the bio-chemical analyzing system of FIG. 6 also includes the microfluidic device and a bio-chemical analyzer 100B. The bio-chemical analyzer 100B and the bio-chemical analyzer 100A are similar except for some portions, and only those different portions are described below.

Referring to FIG. 6, the bio-chemical analyzer 100B includes a collimating lens 117 which is fixed and installed in the light source 115 to uniformly maintain the diameter of the laser L1 emitted from the light source 115. Accordingly, the f-θ lens 150 (refer to FIGS. 3 and 4) is not included. In detail, the collimating lens 117 is inserted into a fixing holder 119, which is attached to the light source 115. As the light source 115 pivots, the collimating lens 117 may pivot with the light source 115.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

What is claimed is:

1. A beam radiating device comprising:
an energy source which is spaced apart from a target and emits an electromagnetic wave beam;
a first pivot unit which pivots the energy source by a first angle on a first pivot axis that does not pass the target; and
a second pivot unit which pivots the energy source by a second angle on a second pivot axis that perpendicularly crosses the first pivot axis and does not pass the target.

2. The beam radiating device of claim 1, wherein the first pivot unit comprises:
a first actuator which is connected to the energy source and rotatably pivots the energy source on the first pivot axis.

3. The beam radiating device of claim 2, wherein the second pivot unit comprises:
a pivot plate which fixedly supports the first actuator; and
a second actuator which rotatably pivots the pivot plate on the second pivot axis.

4. The beam radiating device of claim 1, wherein the energy source comprises a light source that emits a light beam.

5. The beam radiating device of claim 4, further comprising:
a heat radiating element which is attached to the light source and dissipates heat generated by the light source.

6. The beam radiating device of claim 4, further comprising:
an f-θ lens disposed between the light source and the target.

7. The beam radiating device of claim 4, further comprising:
a collimating lens fixed in the light source to uniformly maintain a diameter of a light beam emitted from the light source.

8. A bio-chemical analyzer comprising:
a mount which supports a microfluidic device comprising at least one beam incident zone on which an electromagnetic wave beam is incident; and
a beam radiating device which irradiates the electromagnetic wave beam on the beam incident zone of the microfluidic device supported by the mount, wherein the beam radiating device comprises:
an energy source which is spaced apart from the mount and emits the electromagnetic wave beam;
a first pivot unit which pivots the energy source by a first angle on a first pivot axis that does not pass the mount; and
a second pivot unit which pivots the energy source by a second angle on a second pivot axis that perpendicularly crosses the first pivot axis and does not pass the mount.

9. The bio-chemical analyzer of claim 8, wherein at least one of the first pivot axis and the second pivot axis passes above and is disposed substantially parallel to a microfluidic device support surface of the mount.

10. The bio-chemical analyzer of claim 8, wherein the first pivot unit comprises:
a first actuator which is connected to the energy source and rotatably pivots the energy source on the first pivot axis.

11. The bio-chemical analyzer of claim 10, wherein the second pivot unit comprises:
a pivot plate which fixedly supports the first actuator; and
a second actuator which rotatably pivots the pivot plate on the second pivot axis.

12. The bio-chemical analyzer of claim 8, wherein the energy source comprises a light source emitting a light beam.

13. The bio-chemical analyzer of claim 12, further comprising:
a heat radiating element which is attached to the light source and dissipates heat generated by the light source.

14. The bio-chemical analyzer of claim 12, further comprising:
an f-θ lens which uniformly maintains a diameter of a light beam incident on a surface of the micro fluidic device, regardless of a distance between the light source and the beam incident zone.

15. The bio-chemical analyzer of claim 12, further comprising:
a collimating lens fixed on the light source to uniformly maintain a diameter of a light beam emitted from the light source.

16. The bio-chemical analyzer of claim 8, wherein the mount comprises a turntable that supports and rotates the micro fluidic device.

17. The bio-chemical analyzer of claim 16, further comprising:
a home position detection unit which detects a home position formed on the microfluidic device.

18. A bio-chemical analyzing system comprising:
a microfluidic device which contains a sample to be analyzed and comprises at least one beam incident zone on which an electromagnetic wave beam is incident; and
a bio-chemical analyzer of which irradiates an electromagnetic wave beam on the beam incident zone to analyze the sample, the bio-chemical analyzer comprising:
a mount which supports the microfluidic device; and
a beam radiating device which irradiates the electromagnetic wave beam on the beam incident zone of the microfluidic device supported by the mount, wherein the beam radiating device comprises:
an energy source which is spaced apart from the mount and emits the electromagnetic wave beam;
a first pivot unit which pivots the energy source by a first angle on a first pivot axis that does not pass the mount; and
a second pivot unit which pivots the energy source by a second angle on a second pivot axis that perpendicularly crosses the first pivot axis and does not pass the mount.

19. The bio-chemical analyzing system of claim 18, wherein the beam incident zone comprises:
a valve which controls flow of a fluid contained in the microfluidic device.
